(19) United States
(12) Patent Application Publication
(10) Pub. No.: US 2006/0152029 A1
(43) Pub. Date: Jul. 13, 2006

(54) Automotive tailgate

(76) Inventors: Kris Tomasson, Corona del Ma, CA (US); Brian White, Rancho Santa Margarita, CA (US); Mark Gorman, Valencia, CA (US)

Correspondence Address: BROOKS KUSHMAN P.C./FGTL, 1000 TOWN CENTER, 22ND FLOOR, SOUTHFIELD, MI, 48075-1238, US

(21) Appl. No.: 11/031,295

(22) Filed: Jan. 7, 2005

(51) Int. Cl. B62D 33/03

(52) U.S. Cl. 296/51

(57) ABSTRACT

The present invention discloses a passenger vehicle having a multi-position tailgate. The tailgate may be opened from a driver side or a passenger side. A retractable table for a tailgate is disclosed. The tailgate may also be opened in a third orientation, extending generally horizontally from the vehicle. A method for operating the tailgate is also disclosed.

### BACKGROUND OF THE INVENTION

1. Field of the Invention

The present invention relates generally to doors for passenger vehicles, and more specifically, to automotive tailgates.

2. Background Art

Passenger vehicles having a tailgate at a rear end of the vehicle have been popular for many years. Such tailgates have been provided to a passenger or cargo compartment, such as a rear door on a station wagon, minivan, or SUV. Tailgates have also been provided on the rear end of cargo compartments, such as a bed for a pick-up truck.

Modern day passengers have come to rely on their passenger vehicle for more than just transportation. For example, a rear end of a motor vehicle is often used for supporting food or other social related items. This activity is commonly referred to as picnicking or tailgating.

The prior art has provided tailgates for pick-up trucks that are pivotally mounted to the truck bed about a horizontal axis. The prior art has also provided tailgates that have a window that retracts into the tailgate. The prior art has provided tailgates, for example, for a station wagon, wherein the tailgate is pivotal about a vertical axis and a horizontal axis so that the tailgate may be utilized as a pivotal door or a horizontally extending surface.

Prior art tailgates that pivot about a horizontal axis, are often utilized for assisting loading of cargo into a rear cargo carrying area of the vehicle. Therefore, it is common to provide a surface on an interior side of a tailgate for resisting wear and tear from articles loaded therein.

The prior art has also provided a vehicle with a picnic table accessory that is stowed in a recess in a trunk floor.

In light of the foregoing, what is needed is a multi-functional tailgate that functions as a door and provides other non-transportation features for the passenger. What is also needed is a tailgate that incorporates flexibility for opening to multiple positions. Further, a method for opening a vehicle door is needed.

### SUMMARY OF THE INVENTION

An aspect of the present invention is to provide a passenger vehicle having an elongate tailgate extending across a rear end of the vehicle from a driver-side to a passenger-side. The tailgate is pivotally connected to the body rear end at the driver-side and is selectively detachable from the body at the passenger-side. The tailgate is also pivotally connected at the passenger-side, while selectively detachable from the tailgate driver-side such that the tailgate may be opened in multiple positions.

A further aspect of the present invention is to provide a passenger vehicle with a tailgate at its rear end, the tailgate having a retractable table mounted to an interior side of the tailgate.

Another aspect of the present invention is to provide a rear window oriented above the tailgate.

Yet another aspect of the present invention is to provide a latch mechanism for latching the rear window to the tailgate.

A further aspect of the present invention is to provide a pair of ingress handles, each on one side of the tailgate, for opening the tailgate in a plurality of positions.

Yet another aspect of the present invention is to provide a tailgate that is pivotally connected to the vehicle body about a horizontal axis to provide another direction to open the tailgate.

An aspect of the present invention is to provide a tailgate with an interior panel mounted thereto.

Another aspect of the present invention is to provide a retractable table for a tailgate, having a cutting board.

An additional aspect of the present invention is to provide a tailgate with a retractable table that includes a tray.

A further aspect of the present invention is to provide a tailgate with a retractable table that has a drink holder.

A further aspect of the present invention is to provide a cavity in an interior panel of a tailgate for receiving a retractable table.

Yet another aspect of the present invention is to provide a tailgate having a compartment formed in an interior side.

In one embodiment, the invention provides a tailgate having a retractable table and a compartment, wherein the compartment is accessible when the table is extended from the tailgate.

An aspect of the present invention is to provide a tailgate compartment with dishware storage.

Another aspect of the present invention is to provide a tailgate compartment with a cooler.

Yet another aspect of the present invention is to provide a tailgate compartment with storage for drinking glassware.

An additional aspect of the present invention is to provide a tailgate with plate storage.

Another aspect of the present invention is to provide a method of opening a vehicle door, wherein a passenger actuates one of a pair of ingress handles that are each located on a lengthwise end of the door, and the passenger pivots the door about a pivotal connection provided at the other end of the lengthwise door.

The above aspects, and other aspects, objects, features, embodiments, advantages, and benefits of the present invention are readily apparent from the detailed description of embodiments of the present invention when taken in connection with the accompanying drawings.

### BRIEF DESCRIPTION OF THE DRAWINGS

FIG. 1 is a left-rear perspective view of a passenger vehicle in accordance with the present invention;

FIG. 2 is a rear perspective view of the passenger vehicle of FIG. 1, illustrated with a tailgate opened in a first orientation;

FIG. 3 is an enlarged rear perspective view of the passenger vehicle of FIG. 1, illustrated with the tailgate opened in the orientation of FIG. 2, with a retractable table extending therefrom;

FIG. 4 is a rear perspective view of the passenger vehicle of FIG. 1, illustrated with the tailgate opened in a second orientation; and

FIG. 5 is a rear perspective view of the passenger vehicle of FIG. 1, illustrated with the tailgate opened in a third orientation.

### DETAILED DESCRIPTION OF EMBODIMENTS OF THE INVENTION

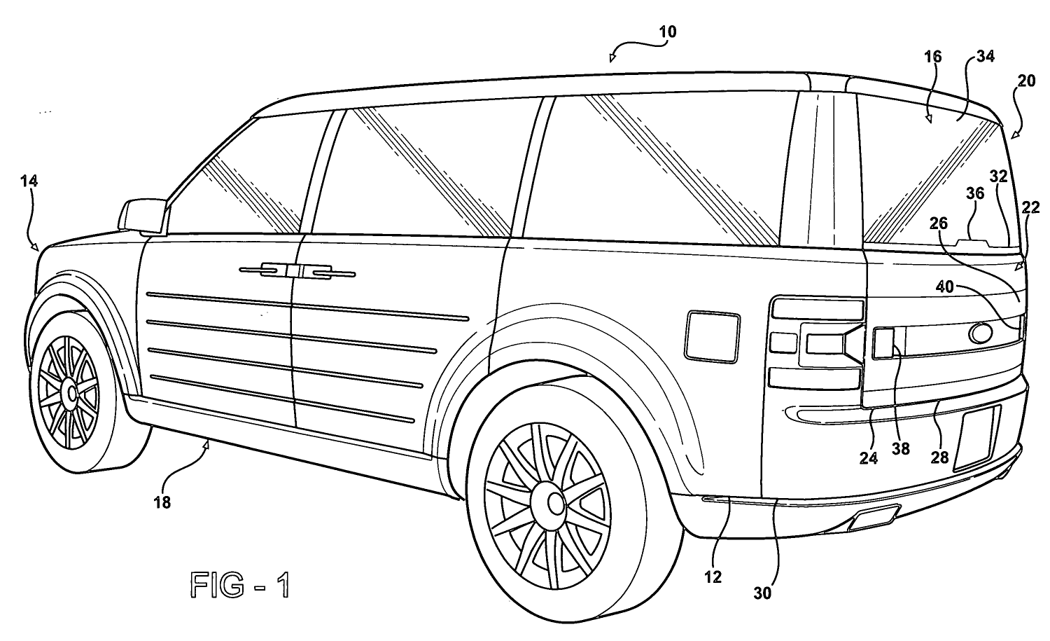

Referring now to FIG. 1, the passenger vehicle is illustrated in accordance with the teachings of the present invention. For example, the passenger vehicle is illustrated as a minivan and is referenced by numeral 10. Although a minivan is illustrated, any passenger vehicle is contemplated within the spirit and scope of the invention, including but not limited to cars, station wagons, SUVs, pick-up trucks or the like.

The vehicle 10 has a vehicle body 12. The vehicle body 12 has a front end 14, a rear end 16, a driver side 18 and a passenger side 20.

The vehicle body rear end 16 includes an elongate tailgate 22 extending thereacross. The tailgate 22 includes a driver-side end 24 and a passenger-side end 26. The tailgate 22 has a bottom end 28, which begins above a rear bumper 30 of the vehicle. The tailgate 22 also includes a top end 32, which forms part of a ridge line of the vehicle body 12. The vehicle 10 includes a rear window 34 provided above the top end 32 of the tailgate 22 and extending to a roof line of the vehicle 10. The tailgate 22 also includes a rear brake light extending from a central region of the top end 32. The brake light 36 extends into the interior of the vehicle 10 and is viewable through the rear window 34.

The tailgate 22 includes a driver-side ingress handle 38 and a passenger-side ingress handle 40. Each ingress handle 38, 40 may be manually actuated for opening the tailgate 22.

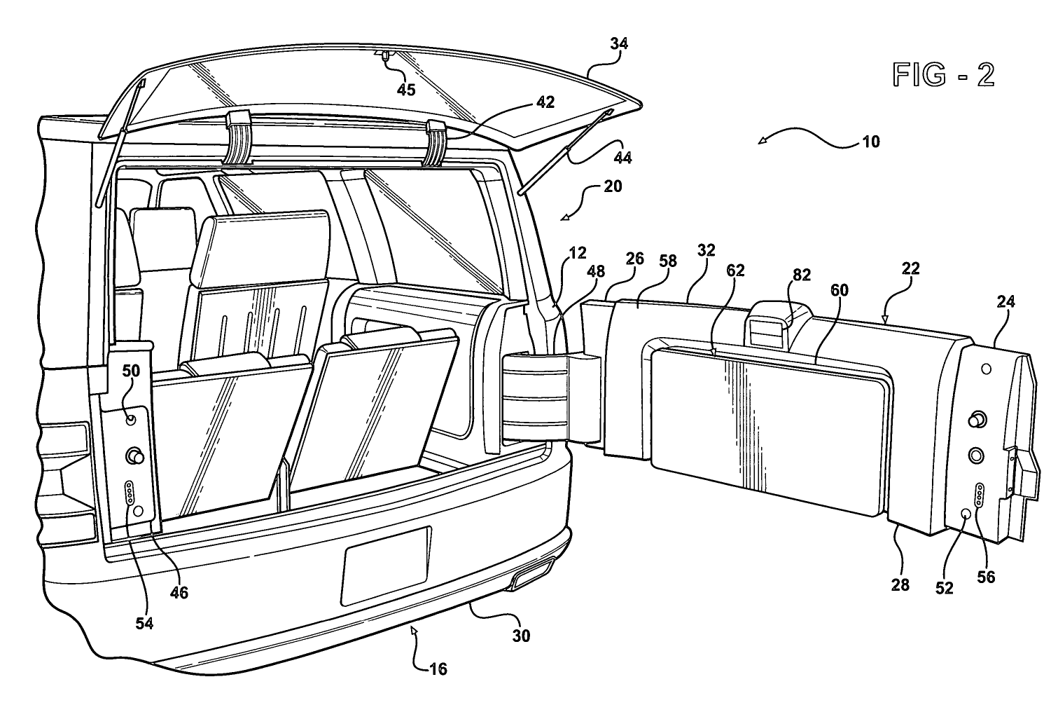

Referring now to FIG. 2, the tailgate 22 is illustrated in an open orientation relative to the vehicle body 12. Since the rear window 34 overlaps the tailgate top end 32, the rear window 34 is open prior to opening the tailgate 22. The rear window 34 is pivotally connected at hinges 42 and is maintained in an open orientation as illustrated in FIG. 2, by a pair of shock absorbers 44.

The tailgate top 32 includes a latching mechanism therein for receiving a striker 45 extending inward form the rear window 34.

As illustrated in FIG. 2, the vehicle includes a driver-side hinge 46 and a passenger-side hinge 48, each secured to the vehicle body 12 for pivoting the tailgate 22 relative thereto about a vertical axis. Each hinge 46, 48 includes a latching mechanism 50 and each tailgate end 24, 26 includes a corresponding latching mechanism 52. The latching mechanisms 50, 52 cooperate to support the tailgate 22 on one or both of the hinges 46, 48.

In a closed orientation of the tailgate 22, as in FIG. 1, the latching mechanisms 50, 52 of both tailgate ends 24, 26 are engaged thereby securing the tailgate 22 to the vehicle body 12. Upon manual actuation of the driver-side ingress handle 38, the latching mechanisms 50, 52 on the driver-side tailgate end 24 disengage. Subsequently, the passenger may pivot the tailgate 22 about the passenger-side hinge 48 to an open orientation as illustrated in FIG. 2. If the passenger desires to open the tailgate 22 in an opposite direction, the passenger actuates the passenger-side ingress handle 40.

The rear window latching mechanism may be unlatched by manual actuation of either ingress handle 38, 40. The tailgate latching mechanisms 50, 52 may include a delay, permitting the rear window 34 to be opened prior to unlatching the tailgate 22.

Since the tailgate 22 may be detached from the rear end of the vehicle 16 at either lateral end 24, 26 of the tailgate 22, it is desirable to not extend a wire harness directly from the vehicle 10 through the tailgate 22. Therefore, each hinge is provided with a receptacle 54 having a series of contacts therein; and each tailgate end 24, 26 is provided with a corresponding plug 56 having a plurality of contacts for engaging the contacts of the receptacle 54. Thus, power and signals that are conveyed to the tailgate 22, for controlling and powering, for example, the brake light 36 or the rear window latching mechanism, are provided through each hinge 46, 48. Regardless of the orientation of the tailgate 22, the tailgate 22 is always wired to the vehicle 10. To avoid redundant signals, an electronic control unit of the vehicle 10 may provide power and signals through only one receptacle 54, when the tailgate 22 is in the closed orientation.

An interior panel 58 is mounted to an interior side of the tailgate 22. The interior panel 58 provides an ornamental covering to the tailgate interior and may also include additional functions. The interior panel 58 has a cavity 60 formed therein. The cavity 60 may receive a retractable table 62 therein. The table 62 is illustrated in a retracted or stowed orientation in FIG. 2. The underside of the table 62 and/or the interior panel 58 may include a resilient surface for resisting wear and tear associated with cargo, which may be transported within the vehicle 10.

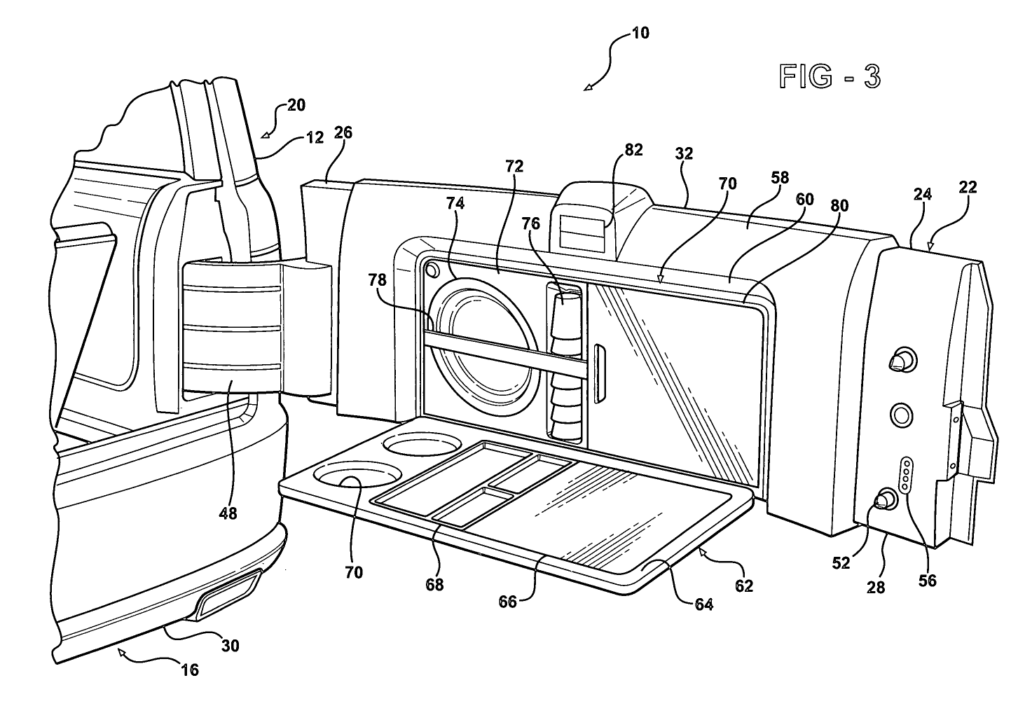

The table 62 is displaced generally upright in its retracted position. With reference now to FIG. 3, the table 62 may be extended from the interior panel 58 about a horizontal pivot axis. The table 62 may have a limited range of rotational translation so that the table 62 is maintained in a horizontal orientation when extended as illustrated in FIG. 3.

In the extended orientation of the table 62, a table top surface 64 is exposed for utilization in picnicking, tailgating, or any other activity, which may require a table.

The table 62 may include various accessories for assisting in picnicking or tailgating. For example, a cutting board 66 may be provided upon the table top surface 64 for utilization in food preparation upon the table 62. Additionally, a tray 68 may be provided in the top surface 64 of the table 62. The tray 68 may include a plurality of tray recesses for receiving food items placed therein. Additionally, the table top surface 64 may include a plurality of drink holders for receiving and supporting drinks therein.

The open orientation of the table 62 exposes a compartment 70 retained within the interior panel cavity 60. The compartment 70 includes a dishware holder 72, which is removable from the compartment 70. The dishware holder 72 is utilized for storing plates 74 and drinking glassware 76 therein. The dishware holder 72 also includes a transverse strap 78 for retaining the plates 74 and the drinking glassware 76 therein when housed within the compartment 70.

The compartment 70 may also include a sealed door 80 for housing food products within the compartment 70 and for maintaining the freshness of the food products. The compartment 70 and sealed door 80 may be insulated for utilization as a cooler. Alternatively, a refrigerator unit may be mounted within the vehicle for cooling the compartment 70 and for maintaining freshness of food items housed therein.

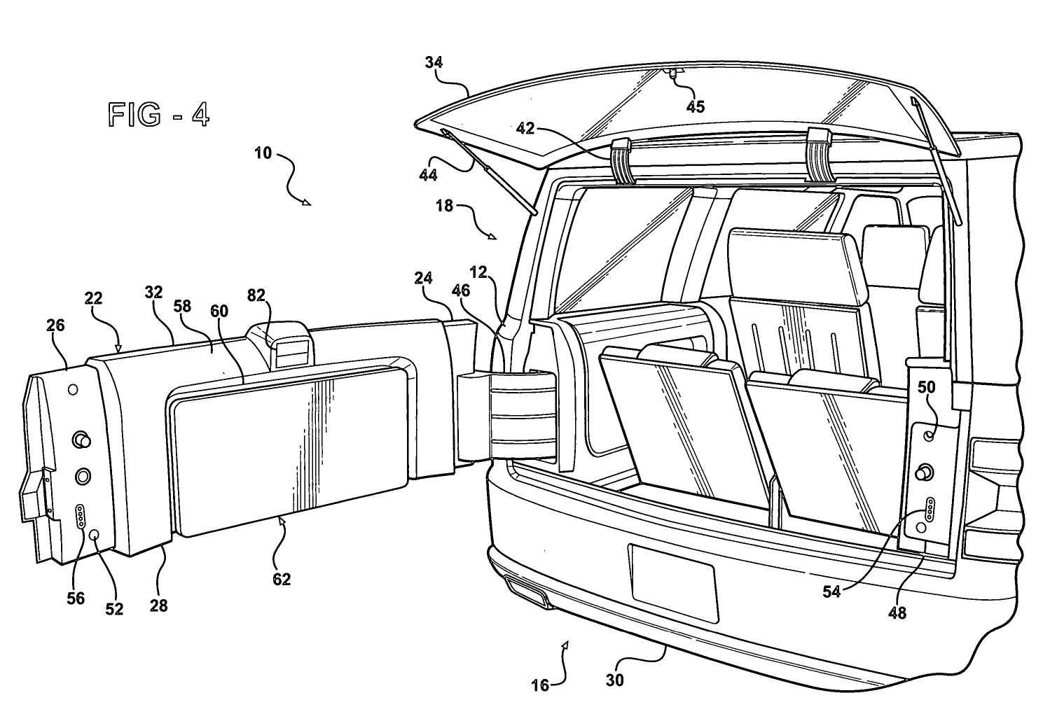

The tailgate 22 may be opened in multiple positions. Referring again to FIG. 1, the tailgate 22 may be opened to another orientation by manual actuation of the passenger-side ingress handle 40. Referring now to FIG. 4, when the manual ingress handle 40 is actuated, the latching mechanisms 50, 52 on the passenger-side tailgate end 26 disengage and the tailgate 22 is translated about the driver-side hinge 46. The receptacle 54 and the plug 56 on the passenger-side tailgate end 26 become disengaged. Thus, any power or signals that are conveyed to the tailgate 22 in this open orientation are conveyed through the receptacle 54 and plug 56 at the driver-side hinge 46 and tailgate end 24. Thus, the passenger is provided with multiple positions to open the tailgate 22 and multiple accessories for enhancing a tailgating or picnicking experience.

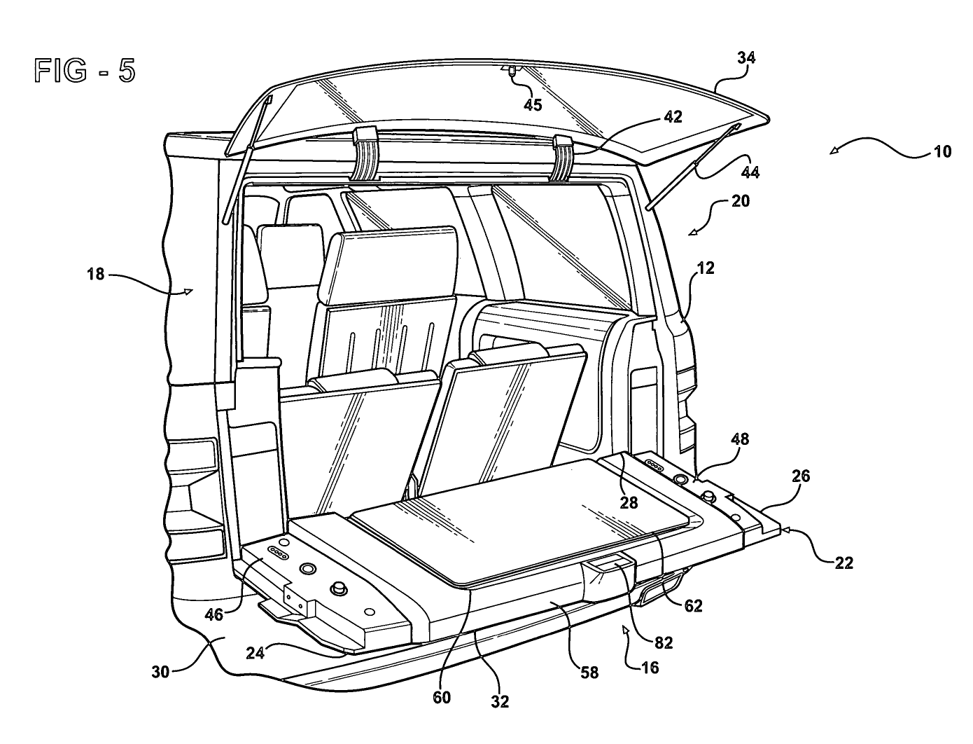

The tailgate 22 may also include a third ingress handle 82 provided, for example, on the interior panel 58 of the tailgate 22. Referring now to FIG. 5, manual actuation of the third ingress handle 82, causes a top portion of the latching mechanisms 50, 52 to become disengaged so that the tailgate 22 may be pivoted about a horizontal pivotal connection collectively provided by the hinges 46, 48. Thus, the tailgate 22 provides a third position, which may facilitate picnicking or tailgating. This horizontal orientation of the tailgate 22 may also be helpful in loading cargo into the vehicle 10.

In summary, a passenger vehicle is disclosed having a tailgate that maximizes flexibility with multiple tailgate positions, and incorporates various features, which may assist the tailgating or picnicking experience, without requiring the passenger to separately pack the these accessories in the cargo compartment.

While embodiments for carrying out the invention have been described in detail, those familiar with the art to which this invention relates will recognize various alternative designs and embodiments for practicing the invention as defined by the following claims.

What is claimed:

1. A passenger vehicle comprising:
a vehicle body having a front end, a driver side, a passenger side and a rear end; and
an elongate tailgate extending across the vehicle body rear end from the driver side to the passenger side, the tailgate having a driver-side end and a passenger-side end respectively;
wherein the tailgate driver-side end is pivotally connected to the vehicle body rear end and the tailgate passenger-side end is selectively detachable from the vehicle body rear end so that a passenger may open the tailgate in a first direction by detaching the tailgate passenger-side end from the vehicle body and pivoting the tailgate relative to the vehicle body about the tailgate passenger-side end; and
wherein the tailgate passenger-side end is pivotally connected to the vehicle body rear end and the tailgate driver-side end is selectively detachable from the vehicle body rear end so that a passenger may open the tailgate in a second direction by detaching the tailgate driver-side end from the vehicle body and pivoting the tailgate relative to the vehicle body about the tailgate driver-side end.

2. The passenger vehicle of claim 1 further comprising a table pivotally connected to an interior side of the tailgate, the table having an upright position for stowing and an extended position that is generally horizontal.

3. The passenger vehicle of claim 1 further comprising:
a first ingress handle provided on the tailgate external from the vehicle proximate to the driver-side end that is manually actuatable for detaching the tailgate driver-side end from the vehicle and for pivoting the tailgate about the tailgate passenger-side end; and
a second ingress handle provided on the tailgate external from the vehicle proximate to the passenger-side end that is manually actuatable for detaching the tailgate passenger-side end from the vehicle and for pivoting the tailgate about the tailgate driver-side end.

4. The passenger vehicle of claim 1 wherein the tailgate includes a bottom end that is pivotally connected to the vehicle body about a horizontal axis and a top end that is selectively detachable from the vehicle body so that a passenger may open the tailgate in a third direction by detaching the tailgate top end from the vehicle body and pivoting the tailgate relative to the vehicle body about the bottom end.

5. The passenger vehicle of claim 1 further comprising a rear window oriented above the tailgate, the rear window being pivotally connected to the vehicle proximate to a roof line of the vehicle.

6. The passenger vehicle of claim 5 further comprising a latching mechanism for latching the rear window to the tailgate.

7. The passenger vehicle of claim 1 further comprising a retractable table mounted to an interior side of the tailgate.

8. The passenger vehicle of claim 7 wherein a top table surface of the table further comprises a cutting board.

9. The passenger vehicle of claim 7 wherein a top table surface of the table further comprises at least one tray recess for receiving a food item therein.

10. The passenger vehicle of claim 7 wherein a top table surface of the table further comprises at least one drink holder formed therein.

11. The passenger vehicle of claim 7 further comprising an interior panel mounted on the interior side of the tailgate, wherein the table is retractable from the tailgate interior panel.

12. The passenger vehicle of claim 11 wherein the tailgate interior panel includes a cavity formed therein that is sized to receive the table in a retracted position of the table.

13. The passenger vehicle of claim 7 therein a compartment is formed in the interior side of the tailgate.

14. The passenger vehicle of claim 13 wherein the tailgate compartment is accessible when the table is extended from the tailgate and the tailgate compartment is inaccessible when the table is retracted.

15. The passenger vehicle of claim 13 wherein the tailgate compartment further comprises dishware storage.

16. The passenger vehicle of claim 13 wherein the tailgate compartment further comprises a cooler.

17. The passenger vehicle of claim 13 wherein the tailgate compartment further comprises drinking glassware storage.

18. The passenger vehicle of claim 13 wherein the tailgate compartment further comprises plate storage.

19. A passenger vehicle comprising:
a vehicle body having a front end, a driver side, a passenger side and a rear end;
an elongate tailgate extending across the vehicle body rear end from the driver side to the passenger side, the tailgate having a driver-side end and a passenger-side end respectively; and
a retractable table mounted to an interior side of the tailgate;
wherein the tailgate is pivotally connected to the vehicle body rear end and the tailgate is selectively detachable from the vehicle body rear end so that a passenger may detach the detachable tailgate end from the vehicle body and pivot the tailgate relative to the vehicle body.

20. A method of opening a vehicle door comprising:
actuating one of a pair of opposed ingress door handles that are each located on a lengthwise end of the door; and
pivoting the door about a pivotal connection provided at the other lengthwise end of the door.
